(19) United States
(12) Patent Application Publication
(10) Pub. No.: US 2020/0099211 A1
(43) Pub. Date: Mar. 26, 2020

(54) PATH REGULATING MEMBER, CLAMP, AND WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Tomoya KAWAGUCHI, Yokkaichi (JP); Yuichi KIMOTO, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/497,185

(22) PCT Filed: Mar. 23, 2018
(86) PCT No.: PCT/JP2018/011712

§ 371 Date: Sep. 24, 2019

(30) Foreign Application Priority Data
Mar. 30, 2017 (JP) 2017-067436

(51) Int. Cl. H02G 3/34; B60R 16/02

(52) U.S. Cl. CPC H02G 3/34; H02G 3/0468; B60R 16/0215

(57) ABSTRACT

A path regulating member that is to be used as a constituent member of a wire harness, the path regulating member including: a body that has an axis along a path along which the wire is arranged, and is configured to regulate the path of the wire from the outside of the external cover, the axis not coinciding with a longitudinal axis of the external cover, wherein an end or an intermediate portion of the body in a direction of the axis that is a supported portion of the body to be supported by the support of the clamp has a noncircular outer peripheral shape that is configured to fit in an annular structure of the support and thus restrict rotation of the body about the axis.

### BACKGROUND

The present disclosure relates to a path regulating member, a clamp, and a wire harness.

As disclosed in JP 2011-155763A, a wire harness is known that includes a spine member that regulates a path along which a wire is arranged from the outside of a corrugated tube that protects the wire.

### SUMMARY

As described above, the path of a wire that is protected by a flexible external covering member such as a corrugated tube can be regulated by coupling the external covering member to a path regulating member (spine member). A clamp is used to couple the path regulating member to the external covering member and couple the path regulating member to a vehicle. Here, the path regulating member that is supported by a support portion of the clamp sometimes rotate about an axis of the path regulating member. If the path regulating member rotates relative to the support portion as described above, wearing of the support portion is accelerated, for example, and as a result, the support of the path regulating member by the clamp may become unstable.

An exemplary aspect of the disclosure provides a clamp, a path regulating member, and a wire harness that enable stable support of a path regulating member that regulates the path of a wire that is covered by an external covering member.

A path regulating member according to an exemplary aspect is a path regulating member that is to be used as a constituent member of a wire harness, wherein the wire harness includes a wire, an external cover that is flexible and covers the wire, and a clamp that includes a support that supports the path regulating member, the path regulating member including a body that has an axis along a path along which the wire is arranged, and is configured to regulate the path of the wire from the outside of the external cover, and a supported portion of the body to be supported by the support of the clamp has a noncircular outer peripheral shape that is configured to fit in an annular structure of the support and thus restrict rotation of the body about the axis.

According to this configuration, rotation of the path regulating member about the axis relative to the support of the clamp is restricted.

It is preferable that the above-described path regulating member includes a lock, and as a result of the lock being locked by the support, movement of the body in a direction of the axis relative to the support is restricted.

According to this configuration, displacement of the path regulating member relative to the support and detachment of the body from the support can be suppressed.

A clamp according to an exemplary aspect is a clamp that is to be used as a constituent member of a wire harness, wherein the wire harness includes a wire, an external cover that is flexible and covers the wire, and a path regulator that has an axis along a path along which the wire is arranged, and regulates the path of the wire from the outside of the external cover, the clamp includes a support that has an annular structure and is configured to support the path regulator, and the annular structure has a noncircular inner peripheral shape that is configured to fit to a supported portion of the path regulator and thus restrict rotation of the path regulator about the axis.

According to this configuration, rotation of the path regulator about the axis relative to the support of the clamp is restricted.

It is preferable that, in the above-described clamp, the annular structure includes a lock, and as a result of the lock locking the supported portion of the path regulator, movement of the path regulator in a direction of the axis relative to the support is restricted.

According to this configuration, displacement of the path regulator relative to the support and detachment of the path regulator from the support can be suppressed.

In the above-described clamp, the support preferably includes a wall to which an end face of the path regulator in a direction of the axis can abut.

According to this configuration, positioning of an end of the path regulator can be performed when the path regulator is to be supported by the support of the clamp, for example.

It is preferable that, in the above-described clamp, the support is configured to support an intermediate portion of the path regulator that is located between both ends thereof in a direction of the axis, and the annular structure of the support includes an insertion that allows for the path regulator to be inserted in a radial direction of the annular structure.

According to this configuration, the path regulator can be supported by the support by inserting the intermediate portion of the path regulator through the insertion in a radial direction of the annular structure of the support.

The above-described clamp preferably further includes at least one of an attachment to which the external cover is to be attached and a fixing portion to be fixed to a vehicle.

According to this configuration, the clamp can be used to couple the path regulator and the external cover to each other and couple the path regulator and the external cover to the vehicle.

A wire harness that solves the above problem is a wire harness that includes a wire, an external cover that is flexible and covers the wire, a path regulator that has an axis along a path along which the wire is arranged, and regulates the path of the wire from the outside of the external cover, and a clamp that includes a support that has an annular structure and supports the path regulator, wherein the annular structure has a noncircular inner peripheral shape that restricts rotation of the path regulator about the axis.

According to the present disclosure, a path regulator that regulates the path of a wire covered by an external cover can be stably supported.

### BRIEF DESCRIPTION OF THE DRAWINGS

FIG. 1 is a schematic plan view showing a wire harness of an embodiment.

FIG. 2 is a schematic diagram showing an arrangement of the wire harness in a vehicle.

FIG. 3 is an exploded perspective view showing a portion of the wire harness.

FIG. 4 is a partial perspective view showing the wire harness.

FIG. 5 is a partial cross-sectional view taken along a line 5-5 in FIG. 4.

FIG. 6 is a partial cross-sectional view taken along a line 6-6 in FIG. 4.

FIG. 7 is an exploded perspective view showing a portion of the wire harness.

FIG. 8 is a partial perspective view showing the wire harness.

FIG. 9 is a partial cross-sectional view showing a wire harness according to a variation.

### DETAILED DESCRIPTION OF EMBODIMENTS

The following describes embodiments of a path regulating member, a clamp, and a wire harness.

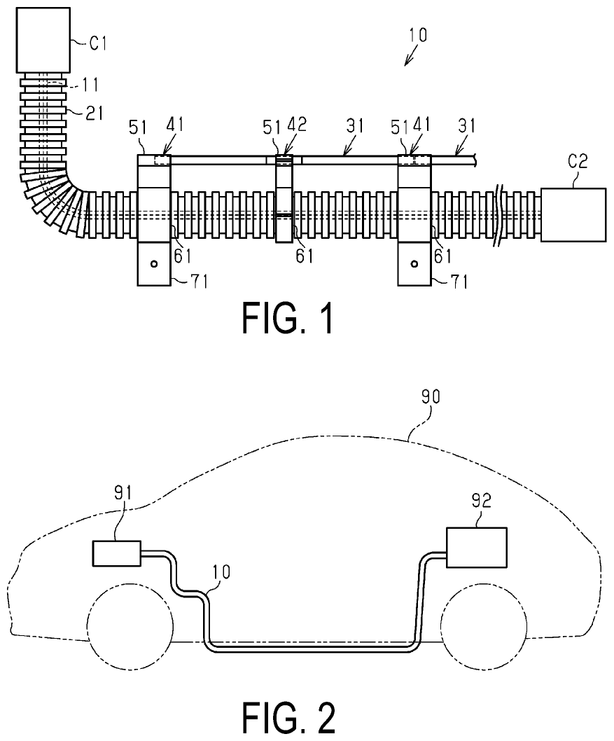

As shown in FIG. 1, a wire harness 10 includes a wire 11, an external covering member 21 (external cover) that is flexible and covers the wire 11, a path regulating member 31 (path regulator) that regulates a path along which the wire 11 is arranged from the outside of the external covering member 21, an end portion clamp 41 that supports an end portion of the path regulating member 31, and an intermediate portion clamp 42 that supports an intermediate portion of the path regulating member 31.

### Arrangement

As shown in FIG. 2, the wire harness 10 is used to electrically connect a first apparatus 91 and a second apparatus 92 to each other that are installed in a vehicle 90. The first apparatus 91 is arranged on the front side of the vehicle 90. The second apparatus 92 is arranged on the rear side of the vehicle 90. For example, one of the first apparatus 91 and the second apparatus 92 is a battery and the other is an inverter. It should be noted that one of the first apparatus 91 and the second apparatus 92 may also be a motor and the other may also be an inverter. Examples of the vehicle 90 include an electric automobile, a hybrid automobile, a fuel-cell automobile, and the like. The wire harness 10 of this embodiment is arranged under the floor of the vehicle 90.

### Wire 11

The wire 11 includes a conductive core wire and an insulating covering. The core wire is made of a conductive material such as copper or aluminum, for example. The core wire is constituted by a single strand or a plurality of strands. The insulating covering is made of an insulating material such as polyvinyl chloride and has a tubular shape as is well known.

Opposite end portions of the wire 11 are respectively constituted by connector portions C1 and C2. The wire 11 is a high-voltage wire and is electrically connected to input/output terminals of the first apparatus 91 and the second apparatus 92 installed in the vehicle 90. The rated voltage of high-voltage wires for vehicles exceeds 30 V in the case of an alternating current and exceeds 60 V in the case of a direct current. It should be noted that the rated voltage of high-voltage wires for vehicles is no greater than 600 V in the case of an alternating current and no greater than 750 V in the case of a direct current.

The wire 11 may include a shield member that serves as a shield against electromagnetic waves, or a shield member against electromagnetic waves may be separately provided on the outer periphery of the wire 11. For example, a braided member that has a mesh structure obtained by braiding metallic threads made of aluminum, stainless steel, copper, an alloy of any of these metals, or the like can be favorably used as the shield member.

### External Covering Member 21

The external covering member 21 is flexible and therefore can deform so as to conform to the wiring path of the wire 11. The external covering member 21 protects the wire 11 by covering the wire 11. The external covering member 21 has a tubular shape having a longitudinal axis, and the wire 11 is arranged in the interior space of the external covering member 21. The external covering member 21 is preferably made of a resin material from the viewpoint of weight reduction, for example. Examples of resin materials include polyolefin, polyamide, polyester, an ABS resin, and the like. Specific examples of the external covering member 21 include a corrugated tube, a hard resin pipe, and the like. It is preferable to use a corrugated tube as the external covering member 21. The corrugated tube has a structure in which a plurality of annular recessed portions are arranged in the direction of the longitudinal axis and is configured to be capable of easily curving or bending.

The external covering member 21 may have a slit that extends in the direction of the longitudinal axis. If the external covering member 21 has a slit, the wire 11 can be arranged inside the external covering member 21 by passing through the slit. It should be noted that, if the external covering member 21 has a slit, the wire 11 can be kept from coming out of the slit by winding a binding member such as adhesive tape around the outer periphery of the external covering member 21 as necessary.

### Path Regulating Member 31

The path regulating member 31 has an axis along the path along which the wire 11 is arranged. The path regulating member 31 is arranged so as to partially regulate the path of the wire 11 from the outside of the external covering member 21. The wire harness 10 may include a single path regulating member 31 or a plurality of path regulating members 31. That is, the wire harness 10 may be configured such that a plurality of sections of the wire 11 are regulated by a plurality of path regulating members 31 or one section of the wire 11 is regulated by a single path regulating member 31. A configuration is also possible in which the path regulating member 31 only has a straight portion, or has a curved portion.

The path regulating member 31 has a noncircular outer peripheral shape. The path regulating member 31 can be formed through, for example, cutting processing for cutting a tubular member or a bar-shaped member to a predetermined length, pressing processing for plastically deforming the outer peripheral shape, bending processing for deforming the path regulating member so as to conform to the wiring path of the wire 11, and the like. Alternatively, the path regulating member 31 can also be molded in a mold.

The path regulating member 31 is made of a material that has sufficient rigidity to maintain the path of the wire 11 arranged inside the external covering member 21. The path regulating member 31 is preferably made of a plastically deformable material from the viewpoint of enabling bending processing. Metallic materials are preferably used as the material of the path regulating member 31. Examples of metallic materials include aluminum, iron, copper, alloys of any of these metals, and the like. It should be noted that the path regulating member 31 may have a tubular shape, in which case, a signal line can be arranged inside the path regulating member 31, for example.

### End Portion Clamp 41 and Intermediate Portion Clamp 42

As shown in FIG. 1, the end portion clamp 41 and the intermediate portion clamp 42 each have a support portion 51 that supports the path regulating member 31 and an attachment portion 61 to which the external covering member 21 is attached. The end portion clamp 41 further has a fixing portion 71 to be fixed to the vehicle 90.

First, the relationship between the support portion 51 of the end portion clamp 41 and the path regulating member 31 will be described.

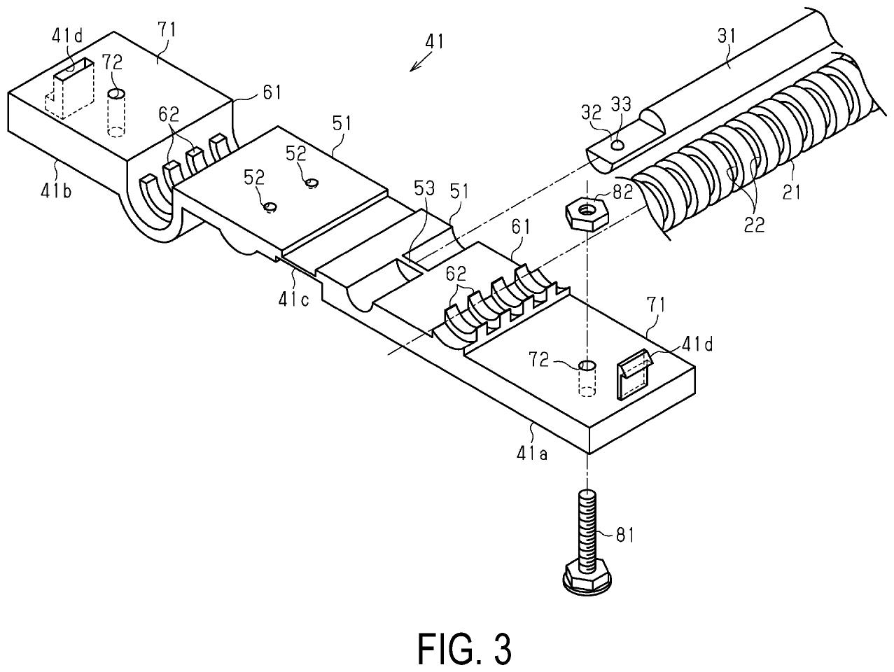

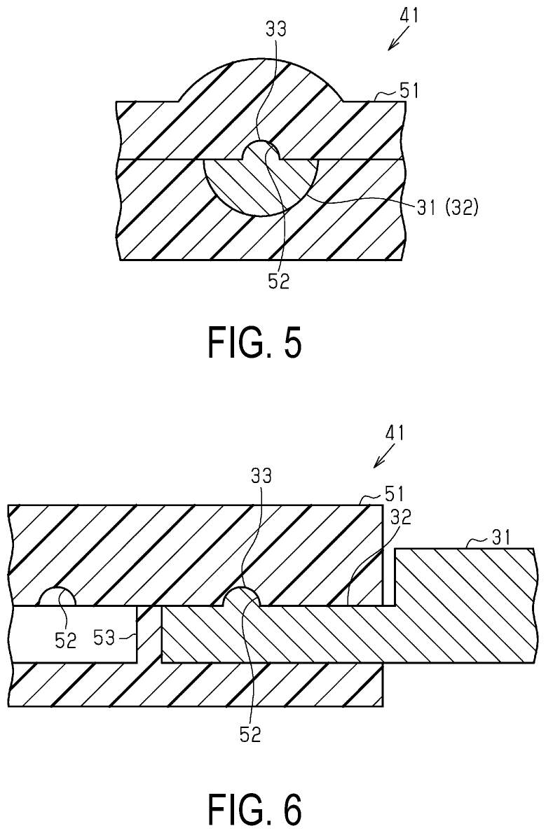

As shown in FIGS. 3 to 5, the support portion 51 of the end portion clamp 41 that supports the path regulating member 31 has an annular structure. The annular structure has a noncircular inner peripheral shape that fits to a supported portion of the path regulating member 31 and thus restricts rotation of the path regulating member 31 about the axis thereof.

In other words, the supported portion of the path regulating member 31 that is supported by the support portion 51 of the end portion clamp 41, that is, an end portion 32 of the path regulating member 31 has a noncircular outer peripheral shape that fits in the annular structure of the support portion 51 and thus restricts rotation of the path regulating member 31 about the axis thereof. The end portion 32 of the path regulating member 31 has a semi-circular outer peripheral shape, for example. The annular structure of the support portion 51 of the end portion clamp 41 has a semi-circular inner peripheral shape, for example, that conforms to the shape of the end portion 32 of the path regulating member 31.

The end portion 32 of the path regulating member 31 is provided with a locking protrusion 33, and as a result of the locking protrusion 33 locking into the support portion 51 of the end portion clamp 41, movement of the path regulating member 31 in its axial direction relative to the support portion 51 is restricted. In other words, the support portion 51 of the end portion clamp 41 has a locking recess 52 in which the locking protrusion 33 of the path regulating member 31 locks, and restricts movement of the path regulating member 31 in its axial direction.

As shown in FIGS. 3, 4, and 6, the support portion 51 of the end portion clamp 41 has a wall portion 53 on which an end face of the path regulating member 31 in its axial direction can abut.

Next, the attachment portion 61 and the fixing portion 71 of the end portion clamp 41 will be described.

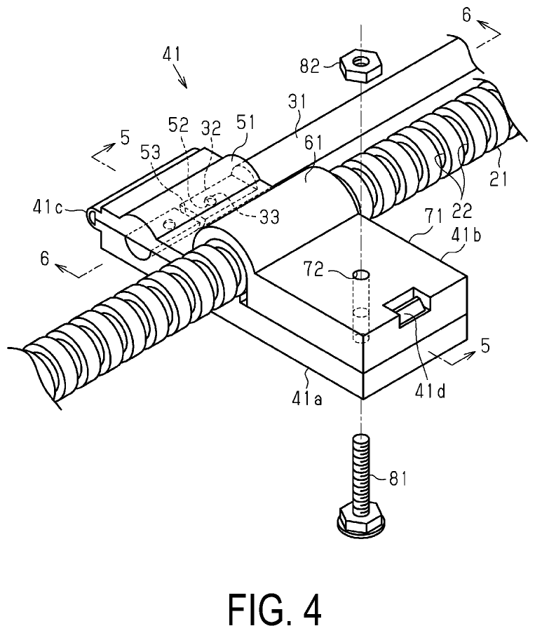

As shown in FIGS. 3 and 4, an intermediate portion of the external covering member 21 in its longitudinal direction is attached to the attachment portion 61 of the end portion clamp 41. The attachment portion 61 has an annular structure that conforms to the outer peripheral shape of the external covering member 21. The inner peripheral surface of the annular structure of the attachment portion 61 has an attachment protrusion 62 that fits in an annular recessed portion 22 of the outer peripheral surface of the external covering member 21 (corrugated tube). In this embodiment, the inner peripheral surface of the annular structure of the attachment portion 61 has a plurality of attachment protrusions 62 so that the protrusions fit in a plurality of annular recessed portions 22 arranged in the longitudinal direction of the external covering member 21, but a configuration is also possible in which a single attachment protrusion 62 is provided.

The fixing portion 71 of the end portion clamp 41 has a through hole 72 for inserting a bolt 81 therethrough. The end portion clamp 41 can be fixed to the vehicle 90 using the bolt 81 and a nut 82. The bolt 81 may be welded to the vehicle 90 in advance. It should be noted that the fixing portion 71 of the end portion clamp 41 may be a clip that locks in an attachment hole provided in the vehicle 90, for example.

Next, details of the structure of the end portion clamp 41 of this embodiment will be described.

As shown in FIGS. 3 and 4, the end portion clamp 41 includes a first main body portion 41a, a second main body portion 41b, and a coupling portion 41c that couples the first main body portion 41a and the second main body portion 41b to each other such that the main body portions can rotate relative to each other. As a result of the coupling portion 41c functioning as a hinge, the first main body portion 41a and the second main body portion 41b of the end portion clamp 41 is configured to be openable and closable so as to change from an open posture shown in FIG. 3 to a closed posture shown in FIG. 4. In the closed posture of the end portion clamp 41, the first main body portion 41a and the second main body portion 41b are overlaid on each other, and the above-described support portion 51, attachment portion 61, and fixing portion 71 are formed. In the end portion clamp 41 taking the closed posture, the support portion 51, the attachment portion 61, and the fixing portion 71 are arranged in this order from the side close to the coupling portion 41c.

The end portion clamp 41 has a lock mechanism 41d that keeps the end portion clamp 41 in the closed posture. The lock mechanism 41d in this embodiment is constituted by a locking claw that is provided in the first main body portion 41a and a locking hole that is formed in the second main body portion 41b. It should be noted that, in the lock mechanism 41d, a locking hole may also be provided in the first main body portion 41a and a locking claw may also be provided in the second main body portion 41b, or the lock mechanism may also be changed to a well-known lock mechanism other than the locking claw and the locking hole.

Next, the relationship between the support portion 51 of the intermediate portion clamp 42 and the path regulating member 31 will be described.

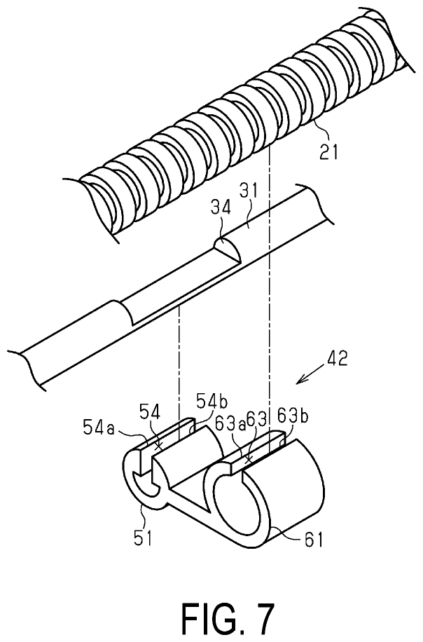

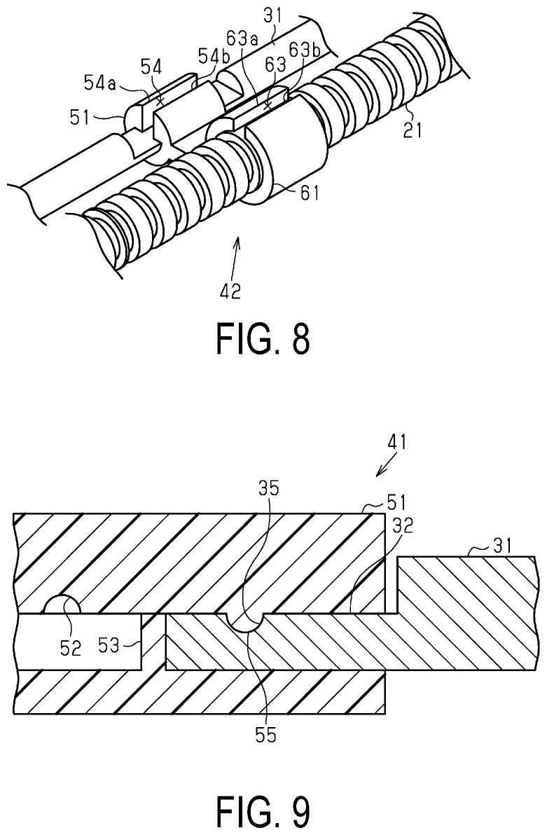

As shown in FIGS. 7 and 8, the support portion 51 of the intermediate portion clamp 42 that supports the path regulating member 31 has an annular structure that conforms to the outer peripheral shape of the path regulating member 31. The annular structure has a noncircular inner peripheral shape that fits to a supported portion of the path regulating member 31 and thus restricts rotation of the path regulating member 31 about the axis thereof.

In other words, the supported portion of the path regulating member 31 that is supported by the support portion 51 of the intermediate portion clamp 42, that is, an intermediate portion 34 of the path regulating member 31 has a noncircular outer peripheral shape that fits in the annular structure of the support portion 51 and thus restricts rotation of the path regulating member 31 about the axis thereof. The intermediate portion of the path regulating member 31 has a semi-circular outer peripheral shape, for example. The annular structure of the support portion 51 of the intermediate portion clamp 42 has a semi-circular inner peripheral shape, for example, that conforms to the shape of the intermediate portion of the path regulating member 31.

The annular structure of the support portion 51 of the intermediate portion clamp 42 includes an insertion portion 54 that allows for the path regulating member 31 to be inserted in a radial direction of the annular structure. That is, the annular structure of the support portion 51 is a noncontinuous annular structure and includes a first end portion 54a and a second end portion 54b that is spaced apart from the first end portion 54a and is located opposite to the first end portion 54a. The annular structure of the support portion 51 is configured to be deformable between a first posture that allows for the path regulating member 31 to be inserted through the insertion portion 54 between the first end portion 54a and the second end portion 54b and a second posture in which the path regulating member 31 that has been inserted through the insertion portion 54 can be supported. That is, the annular structure of the support portion 51 is elastically deformable so as to enlarge the space between the first end portion 54a and the second end portion 54b (the width of the insertion portion 54). It should be noted that the support portion 51 of the intermediate portion clamp 42 may also be configured such that the first end portion 54a and the second end portion 54b come into contact with each other in the second posture.

Next, the attachment portion 61 of the intermediate portion clamp 42 will be described.

As shown in FIGS. 7 and 8, an intermediate portion of the external covering member 21 in its longitudinal direction is attached to the attachment portion 61 of the intermediate portion clamp 42. The attachment portion 61 has an annular structure that conforms to the outer peripheral shape of the external covering member 21. The annular structure of the attachment portion 61 includes an insertion portion 63 that allows for the external covering member 21 to be inserted in a radial direction of the annular structure. That is, the annular structure of the attachment portion 61 is a noncontinuous annular structure and includes a first end portion 63a and a second end portion 63b that is spaced apart from the first end portion 63a and is located opposite to the first end portion 63a. The annular structure of the attachment portion 61 is configured to be deformable between a first posture that allows for the external covering member 21 to be inserted through the insertion portion 63 between the first end portion 63a and the second end portion 63b and a second posture in which the external covering member 21 that has been inserted through the insertion portion 63 can be supported. That is, the annular structure of the attachment portion 61 is elastically deformable so as to enlarge the space between the first end portion 63a and the second end portion 63b (the width of the insertion portion 63). It should be noted that the attachment portion 61 of the intermediate portion clamp 42 may also be configured such that the first end portion 63a and the second end portion 63b come into contact with each other in the second posture.

The end portion clamp 41 and the intermediate portion clamp 42 can be made of metallic materials or resin materials. The end portion clamp 41 and the intermediate portion clamp 42 are preferably made of resin materials from the viewpoint of weight reduction, for example. Examples of resin materials include polyolefin, polyamide, polyester, an ABS resin, and the like.

### Manufacturing Method

Next, one example of manufacturing methods of the wire harness 10 will be described.

When the end portion clamp 41 of this embodiment is changed from the open posture shown in FIG. 3 to the closed posture shown in FIG. 4, the path regulating member 31 can be supported by the support portion 51 and the external covering member 21 can be attached to the attachment portion 61.

In the intermediate portion clamp 42 shown in FIG. 7, the support portion 51 and the attachment portion 61 have the insertion portions 54 and 63, respectively. Therefore, even after both end portions 32 of the path regulating member 31 are supported by the support portions 51 of the end portion clamps 41, an intermediate portion of the path regulating member 31 can be supported by the intermediate portion clamp 42. Also, even after the external covering member 21 is attached to the attachment portions 61 of the end portion clamps 41, the external covering member 21 can be attached to the attachment portion 61 of the intermediate portion clamp 42 by inserting the external covering member 21 through the insertion portion 63 in a radial direction of the attachment portion 61 of the intermediate portion clamp 42.

The thus obtained wire harness 10 preferably includes at least one pair of end portion clamps 41 that support the both end portions 32 of the path regulating member 31. In this case, the pair of end portion clamps 41 have the fixing portions 71 to be fixed to the vehicle 90, and therefore the path regulating member 31 can be stably fixed relative to the vehicle 90. It should be noted that the path regulating member 31 can also be fixed to the vehicle 90 using a clamp other than the end portion clamp 41 and the intermediate portion clamp 42.

Next, functions and effects of this embodiment will be described.

(1) The path regulating member 31 of the wire harness 10 has an axis along a path along which the wire 11 is arranged, and regulates the path of the wire 11 from the outside of the external covering member 21. Supported portions of the path regulating member 31 that are supported by the support portions 51 of the end portion clamp 41 and the intermediate portion clamp 42 have noncircular outer peripheral shapes that fit in the annular structures of the support portions 51 and thus restrict rotation of the path regulating member 31 about the axis thereof.

According to this configuration, rotation of the path regulating member 31 about the axis thereof relative to the support portions 51 of the end portion clamp 41 and the intermediate portion clamp 42 is restricted. Therefore, the path regulating member 31 that regulates the path of the wire 11 covered by the external covering member 21 can be stably supported.

(2) The path regulating member 31 is provided with the locking protrusion 33, and as a result of the locking protrusion 33 locking into the support portion 51 of the end portion clamp 41, movement of the path regulating member 31 in its axial direction relative to the support portion 51 is restricted. In this case, displacement of the path regulating member 31 relative to the support portion 51 and detachment of the path regulating member 31 from the support portion 51 can be suppressed. Therefore, the path regulating member 31 that regulates the path of the wire 11 covered by the external covering member 21 can be stably supported.

(3) The end portion clamp 41 and the intermediate portion clamp 42 each have the support portion 51 that has an annular structure and supports the path regulating member 31. The annular structure has a noncircular inner peripheral shape that fits to a supported portion of the path regulating member 31 and thus restricts rotation of the path regulating member 31 about the axis thereof. According to this configuration, the same functions and effects as those described in the above section (1) can be achieved.

(4) The annular structure of the support portion 51 of the end portion clamp 41 includes the locking recess 52, and as a result of the locking recess 52 locking the supported portion of the path regulating member 31, movement of the path regulating member 31 in its axial direction is restricted. In this case, the same functions and effects as those described in the above section (2) can be achieved.

(5) The support portion 51 of the end portion clamp 41 has the wall portion 53 on which an end face of the path regulating member 31 in its axial direction can abut. In this case, positioning of the end portion 32 of the path regulating member 31 can be performed when the path regulating member 31 is to be supported by the support portion 51 of the end portion clamp 41, for example. Therefore, the path regulating member 31 can be easily supported by the support portion 51 of the end portion clamp 41.

(6) The annular structure of the support portion 51 of the intermediate portion clamp 42 includes the insertion portion 54 that allows for the path regulating member 31 to be inserted in a radial direction of the annular structure. In this case, the path regulating member 31 can be supported by the support portion 51 by inserting an intermediate portion of the path regulating member 31 through the insertion portion 54 in a radial direction of the annular structure of the support portion 51. Therefore, for example, even a path regulating member 31 that is relatively long can be smoothly supported by the intermediate portion clamp 42. Furthermore, the intermediate portion clamp 42 can be easily added to a portion that needs to be supported in the intermediate portion of the path regulating member 31, for example. This can increase freedom of design of the wire harness 10.

(7) The end portion clamp 41 has the attachment portion 61 to which the external covering member 21 is attached and the fixing portion 71 to be fixed to the vehicle 90. In this case, the end portion clamp 41 can be used to couple the path regulating member 31 and the external covering member 21 to each other and couple the path regulating member 31 and the external covering member 21 to the vehicle 90.

(8) The inner peripheral surface of the annular structure of the attachment portion 61 of the end portion clamp 41 has the attachment protrusion 62 that fits in the annular recessed portion 22 of the outer peripheral surface of the external covering member 21. In this case, movement of the external covering member 21 in its longitudinal direction relative to the attachment portion 61 of the end portion clamp 41 can be restricted. Therefore, the external covering member 21 can be stably attached to the attachment portion 61 of the end portion clamp 41, for example.

The above embodiments may also be changed as follows.

The noncircular outer peripheral shape of the supported portion of the path regulating member 31 is not limited to a semi-circular shape, and may also be, for example, an elliptical shape, a triangular shape, or the like. Also, the inner peripheral shapes of the support portions 51 of the end portion clamp 41 and the intermediate portion clamp 42 can be changed according to the outer peripheral shape of the supported portion of the path regulating member 31.

The path regulating member 31 may also have a configuration in which only the both end portions 32 supported by the end portion clamps 41 and the intermediate portion 34 supported by the intermediate portion clamp 42 have noncircular outer peripheral shapes, or the path regulating member 31 has a noncircular outer peripheral shape across its entire length.

The wall portion 53 in the support portion 51 of the end portion clamp 41 can also be omitted.

The intermediate portion clamp 42 can also be configured as a clamp that has the structure of the end portion clamp 41, with the wall portion 53 omitted.

The locking protrusion 33 of the path regulating member 31 can also be omitted. That is, the locking recess 52 of the end portion clamp 41 can also be omitted.

The locking recess 52 of the end portion clamp 41 may also be applied to the support portion 51 of the intermediate portion clamp 42 to restrict movement of the path regulating member 31 in its axial direction relative to the support portion 51 of the intermediate portion clamp 42. That is, the locking protrusion 33 of the path regulating member 31 can be provided not only in the end portion 32 but also in the intermediate portion 34.

The attachment protrusion 62 in the attachment portion 61 of the end portion clamp 41 can also be omitted. It should be noted that an attachment protrusion that fits in the annular recessed portion 22 of the outer peripheral surface of the external covering member 21 can also be provided in the attachment portion 61 of the intermediate portion clamp 42.

As shown in FIG. 9, the locking protrusion 33 of the path regulating member 31 may also be changed to a locking recess 35 and the locking recess 52 of the end portion clamp 41 may also be changed to a locking protrusion 55.

The support portion 51 of the intermediate portion clamp 42 may also be changed to a continuous annular structure by omitting the insertion portion 54 in the support portion 51.

The attachment portion 61 of the intermediate portion clamp 42 may also be changed to a continuous annular structure by omitting the insertion portion 63 in the attachment portion 61.

Although the support portion 51 of the end portion clamp 41 is configured to sandwich the end portion 32 of the path regulating member 31 between the first main body portion 41a and the second main body portion 41b, the support portion 51 may also be changed such that the first main body portion 41a and the second main body portion 41b are formed as a single piece. In this case, the path regulating member 31 can be supported by the support portion 51 by inserting (press fitting) the end portion 32 of the path regulating member 31 into the support portion 51.

The support portion 51 of the end portion clamp 41 may also be configured to support path regulating members 31 on both sides of the wall portion 53 or support a single path regulating member 31 on one side of the wall portion 53.

The wire harness 10 is only required to include at least one clamp selected from the above-described end portion clamp 41 and intermediate portion clamp 42, and may further include a clamp other than the above-described end portion clamp 41 and intermediate portion clamp 42.

The wire 11 of the wire harness 10 may also be a low-voltage wire, and positions that are electrically connected by the wire harness 10 can also be changed as appropriate.

Constituent elements in the above-described embodiments and variations thereof may be combined.

It will be apparent to those skilled in the art that the present disclosure may be embodied in other specific forms without departing from the technical concept of the disclosure. For example, some of the components described in the embodiments (or one or more aspects thereof) may be omitted and/or combined.

1. A path regulating member that is to be used as a constituent member of a wire harness,
wherein the wire harness includes a wire, an external cover that is flexible and covers the wire, and a clamp that includes a support that supports the path regulating member, the path regulating member comprising:
a body that has an axis along a path along which the wire is arranged, and is configured to regulate the path of the wire from the outside of the external cover, the axis not coinciding with a longitudinal axis of the external cover,
wherein an end or an intermediate portion of the body in a direction of the axis that is a supported portion of the body to be supported by the support of the clamp has a noncircular outer peripheral shape that is configured to fit in an annular structure of the support and thus restrict rotation of the body about the axis.

2. The path regulating member according to claim 1, further comprising
a lock,
wherein, as a result of the lock being locked by the support, movement of the body in the direction of the axis relative to the support is restricted.

3. The path regulating member according to claim 1, wherein the body has a shape of a bar.

4. A clamp that is to be used as a constituent member of a wire harness,
wherein the wire harness includes a wire, an external cover that is flexible and covers the wire, and a path regulator that has an axis along a path along which the wire is arranged, and regulates the path of the wire from the outside of the external cover, the axis of the path regulator not coinciding with a longitudinal axis of the external cover, wherein the clamp comprising:
a support that has an annular structure and is configured to support the path regulator,
wherein the annular structure has a noncircular inner peripheral shape that is configured to fit to an end or an intermediate portion of the path regulator in a direction of the axis that is a supported portion of the path regulator, and thus restrict rotation of the path regulator about the axis.

5. The clamp according to claim 4,
wherein the annular structure includes a lock, and as a result of the lock locking the supported portion of the path regulator, movement of the path regulator in the direction of the axis relative to the support is restricted.

6. The clamp according to claim 4,
wherein the support includes a wall to which an end face of the path regulator in the direction of the axis can abut.

7. The clamp according to claim 4,
wherein the support is configured to support an intermediate portion of the path regulator that is located between both ends thereof in the direction of the axis, and the annular structure of the support includes an insertion that allows for the path regulator to be inserted in a radial direction of the annular structure.

8. The clamp according to claim 4, further comprising
at least one of an attachment to which the external cover is to be attached and a fixing portion to be fixed to a vehicle.

9. The clamp according to claim 4,
wherein the path regulator has a shape of a bar.

10. A wire harness comprising:
a wire;
an external cover that is flexible and covers the wire;
a path regulator that has an axis along a path along which the wire is arranged, and regulates the path of the wire from the outside of the external cover, the axis of the path regulator not coinciding with a longitudinal axis of the external cover; and
a clamp that includes a support that has an annular structure and supports the path regulator,
wherein the annular structure has a noncircular inner peripheral shape that fits to an end or an intermediate portion of the path regulator in a direction of the axis that is a supported portion of the path regulator, and thus restricts rotation of the path regulator about the axis.

11. The wire harness according to claim 10,
wherein the path regulator has a shape of a bar.
